(19) United States
(12) Patent Application Publication
(10) Pub. No.: US 2005/0027673 A1
(43) Pub. Date: Feb. 3, 2005

(54) Method and apparatus for handling digital content in a network

(75) Inventors: Mitsuaki Moritani, Yokohama-shi (JP); Yasuhiro Morioka, Yokohama-shi (JP); Hiroshi Niina, Kawasaki-shi (JP); Kazuaki Iwamura, Ome-shi (JP); Ken Kishida, Hamura-shi (JP)

Correspondence Address: FOLEY & LARDNER, 2029 CENTURY PARK EAST, SUITE 3500, LOS ANGELES, CA, 90067, US

(73) Assignee: KABUSHIKI KAISHA TOSHIBA

(21) Appl. No.: 10/789,491

(22) Filed: Feb. 26, 2004

(30) Foreign Application Priority Data
Jul. 28, 2003 (JP) 2003-202561

(51) Int. Cl. G06F 7/00

(52) U.S. Cl. 707/1

(57) ABSTRACT

A digital content management apparatus is capable of collectively displaying a list of content present on a network in an easy-to-use way. A content management server determines whether identical content is present when creating a display list of content managed by plural, different a audio video devices connected to the network. When identical content is present, the server creates a display list such that identical content is displayed according to designated conditions, such as in order of transmission speed of servers, based on a setting file.

### CROSS-REFERENCE TO RELATED APPLICATIONS

This application is based upon and claims the benefit of priority from the prior Japanese Patent Application No. 2003-202561, filed Jul. 28, 2003, the entire contents of which are incorporated herein by reference.

### BACKGROUND OF THE INVENTION

1. Field of the Invention

The present invention relates to a content management apparatus that provides services for searching for and transmitting content such as video and music between various devices connected to a network, and more particularly to content management technology for collectively managing content.

2. Description of the Related Art

In recent years, network communication standards, for example, suitable for home LANs (local area networks) for use at home have been proposed. For example, a communication standard called UPnP (Universal Plug and Play) establishes communication procedures for freely exchanging content such as video and music between various devices such as personal computers (PCs) and digital television sets (digital TVs) connected to a network (refer to, for example, “UPnP Device Architecture” on the Web site of UPnP Forum at http://www.upnp.org).

As examples of devices connected to a network, there are devices (sometimes expressed as AV devices hereinafter) that have built-in storage devices such as hard disk drives (HDDs) for storing content such as video and music (sometimes expressed as AV content hereinafter) and record or reproduce the AV content.

A system is being developed in which by connecting such various AV devices (including PCs) to a network and using the aforementioned network communication standard, operations between the AV devices such as searching for, moving, duplicating and reproducing AV content respectively stored in the AV devices are made possible.

In order to realize a system that allows free exchange of AV content between various AV devices connected to a network, a content management server that collectively manages the content is required.

For a general user to search for desired content on a network and perform operations such as duplication and reproduction with ease, the function of collectively displaying a list of content found in the search is useful. However, the method by which simply a list of content present on a network is displayed has an inconvenient drawback, because when identical content is present at different locations on the network, obviously, all of them will be displayed.

### BRIEF SUMMARY OF THE INVENTION

According to an embodiment of the invention, there is provided a content management apparatus having an acquiring unit and a sorting unit. The acquiring unit acquires content information indicative of attributes of content respectively stored in a plurality of storage devices connected to a network. The sorting unit operates, under software control, to execute sort processing of list information according to setting information defining display methods. The sorting unit is operative when creating the list information of the respective content using the content information.

When identical information is found in preparing the list information, the sorting unit refers to the setting file to define display methods to present the list information in user selectable display options.

Embodiments of the invention may also be characterized as a content management apparatus having an acquiring unit for acquiring content information indicative of attributes of content respectively stored in a plurality of storage devices connected to a network; and a sorting unit for, when creating list information of the respective content using the content information and displaying the list information in a unified format, creating display list information according to filter-setting information defining display methods.

Still further embodiments of the invention are directed toward a content management method applied to a content management apparatus collectively managing content respectively stored in a plurality of storage devices connected to a network. The method includes the steps of acquiring content information indicative of attributes of content from each of the storage devices; executing first sort processing for creating list information to be displayed in a unified format using the content information; and executing second sort processing on the list information after the first sort processing according to setting information defining display methods for use when identical content is present.

In yet another embodiment, there is provided a content management method which further includes executing filter processing in which, using filter-setting information defining additional display methods according to content reproduction conditions, content failing to meet the reproduction conditions is identified from the list information and a display style of the identified content is set. The method further includes creating display list information for displaying the list information in a unified format including the display style of the identified content set by the filter processing.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram for illustrating the structure of a home server according to an embodiment of the present invention;

FIG. 2 is a block diagram showing the structure of a network system according to the embodiment;

FIG. 3 shows an example of order of priority in displaying a content list according to the embodiment;

FIG. 4 shows an example of display conditions for identical content according to the embodiment;

FIG. 5 shows an example of a display of a content list according to the embodiment;

FIG. 6 is a flowchart for illustrating search processing on content information according to the embodiment;

FIG. 7 is a flowchart for illustrating the steps of performing sort processing on identical content information according to the embodiment;

FIG. 8 is a table for illustrating a filter-setting file according to another embodiment of the present invention; and

FIG. 9 is a flowchart for illustrating processing steps according to said another embodiment.

### DETAILED DESCRIPTION OF THE INVENTION

An embodiment of the present invention will now be described with reference to the drawings.

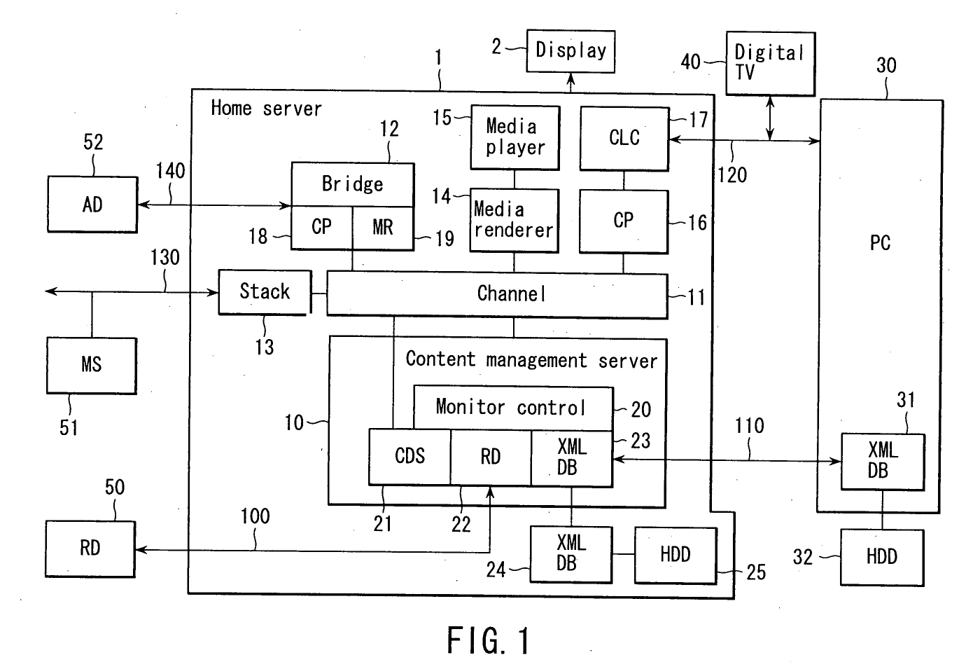

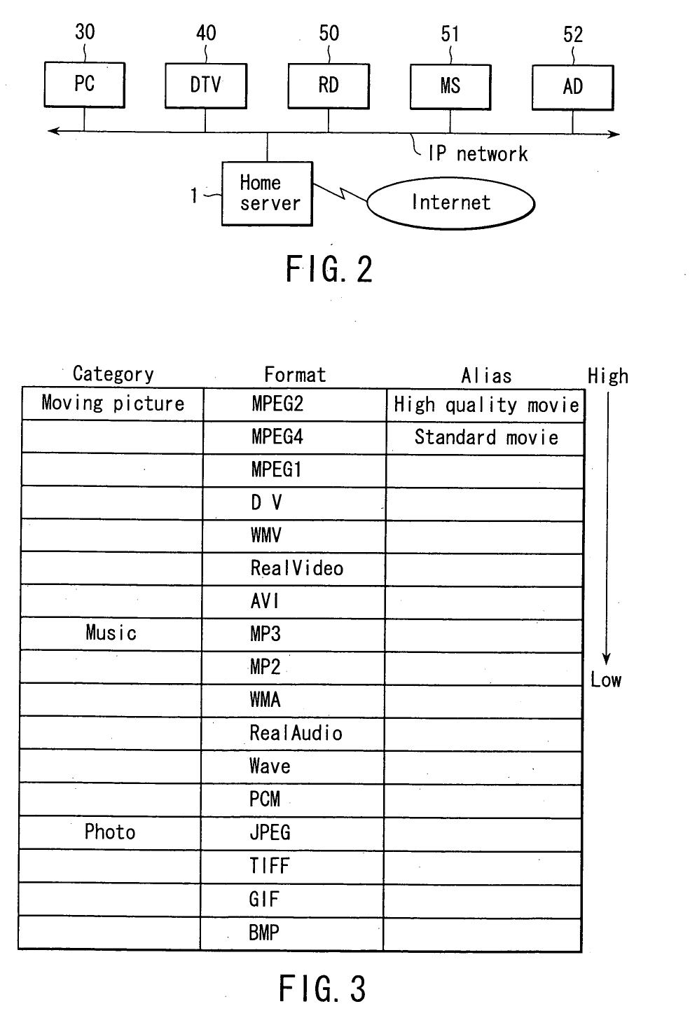

FIG. 1 is a block diagram for illustrating the structure of a home server 1 according to the embodiment. FIG. 2 is a block diagram illustrating the structure of a network system according to the embodiment.

In the system, as shown in FIG. 2, the home server 1 and various AV devices are connected on an IP network. The IP network may be, for example, within an organization's network such as a home LAN, or the Internet. In this embodiment, the home server 1 is connected to the Internet.

AV devices include, for example, a personal computer (PC) 30, a digital TV 40, a video recorder (RD) 50, a media server (MS) 51 and an audio device (AD) 52. The RD 50 is a recorder that uses a disk, such as a DVD recorder or a HDD recorder. The MS 51 is a device that is applied to, for example, the network communication standard of UPnP, and has a medium for storing AV content. The AD 52 is a digital audio device that records and reproduces digital audio data.

(Structure of a Home Server)

The home server 1, as shown in FIG. 1, is broadly divided into a content management server 10 and an interface that performs communication control, etc., with each AV device. The home server 1 realizes an arrangement (system) that allows seamless access of content distributed among the AV devices on the network, including the content managed by the home server 1 itself. The home server 1 is realized, for example, with a personal computer and software.

The content management server 10 has the function of performing what is called content directory service (CDS), and has a monitor control section 20 that performs query processing in which a query about content information is accepted via a controller and processing such that a search is performed. The monitor control section 20 manages, as subordinates, a CDS monitor 21, an RD monitor 22 and an XMLDB monitor 23, and assigns accepted query processing to them, respectively.

The XMLDB monitor 23 performs query processing (such as a search) directed to an XML database 24 (XMLDB) that manages content information written in XML (extensible markup language) or to an XMLDB 31 connected to an XML protocol-compliant network 110. The XMLDBs 24, 31 respectively control HDDs 25, 32 storing content information, to perform DB manipulations.

In the embodiment, the content management server 10 performs the content-list displaying function of collectively displaying content present on the network. The home server 1 displays a content list produced by the content management server 10 by a display 2 such as an LCD (liquid crystal display).

The interface has a channel 11, a bridge 12, a stack 13, a media renderer 14, a media player 15, a control point (CP) 16 and a component (hardware or software) called content library control (CLC) 17.

The channel 11 is, for example, a UPnP channel layer, and corresponds to a communication interface between an interface and the content management server 10. The bridge 12 controls, for example, the AD 52 connected to a network 140 that complies with a communication protocol for digital audio. The bridge 12 includes a CP 18 and a media renderer 19, and fetches AV content from the AD 52 or transmits AV content in the server 1 to the AD 52. The CPs 16, 18 refer to software that controls the AV devices via the network.

The stack 13 is, for example, a UPnP protocol stack, and is used to control the media server (MS) 51 connected to a network 130 that complies with the communication protocol within the stack. The MS 51 is an AV device having the function of storing content information corresponding to the protocol of the network 130.

The media renderer 14 and the media player 15 are software for reproducing AV content fetched from inside the home server 1 and the AV devices. The CLC 17 controls transmission of AV content, for example, to the PC 30 and the digital TV 40 connected to a network 120 that complies with a communication protocol different from the UPnP standard.

Note that the AV devices 30, 40, 50-52 are basically media servers, each of which has, in the inside, a storage device (such as a HDD) and a communication device. Each AV device stores AV content in the storage device, and instructions concerning searches and manipulations of the AV content are allowed to be provided from the outside through the communication device.

(Content List Display Method)

A content list display method according to the embodiment will now be described with reference to FIGS. 3-7 in addition to FIG. 1.

The content management server 10 accepts a query about content information, for example, from the PC 30, through the interface, and searches for the content information of the AV content present in the XMLDB 24 of the content management server 10 itself and in the storage device of each AV device connected to the network. Then, the content management server 10 performs display processing of collectively displaying by the display 2 the AV content present on the network including the content management server 10 itself.

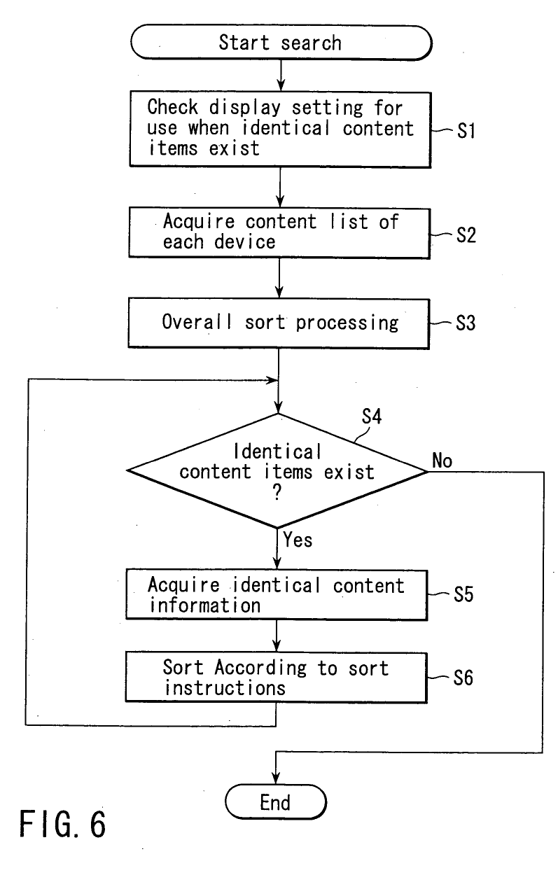

In the embodiment, if the content management server 10 judges that identical content is present at. different locations on the network when displaying a list of the AV content, the content management server 10 displays a list of the AV content according to a designated sort method. Search processing for content information according to the embodiment will now be described with reference to the flowchart of FIG. 6.

The content management server 10, when searching for the content information of the AV content present on the network including the XMLDB 24 of the content management server 10 itself, checks display settings for use when identical content is present at different locations on the network (step S1). More specifically, the server 10 checks a setting file that defines the display methods of redundant content according to the user's designation.

The content management server 10 searches for the content information of the AV content stored in each AV device, using the CDS monitor 21, the RD monitor 22 and the XMLDB monitor 23, and acquires a content list (step S2). Content information includes attribute information of AV content such as its category, data format (reproduction format), title, date and size.

The content management server 10 performs overall sort processing of the entire retrieved content information (step S3). The content management server 10, as shown in FIG. 3, performs sort processing based on the order of priority defined for each category.

Next, the content management server 10 determines whether identical content is present at different locations on the network based on the retrieved content information (step S4). If identical content is not present, the content management server 10 performs processing for displaying in list form the list information created by the overall sort processing, for example, by the display 2 (“NO” in step S4).

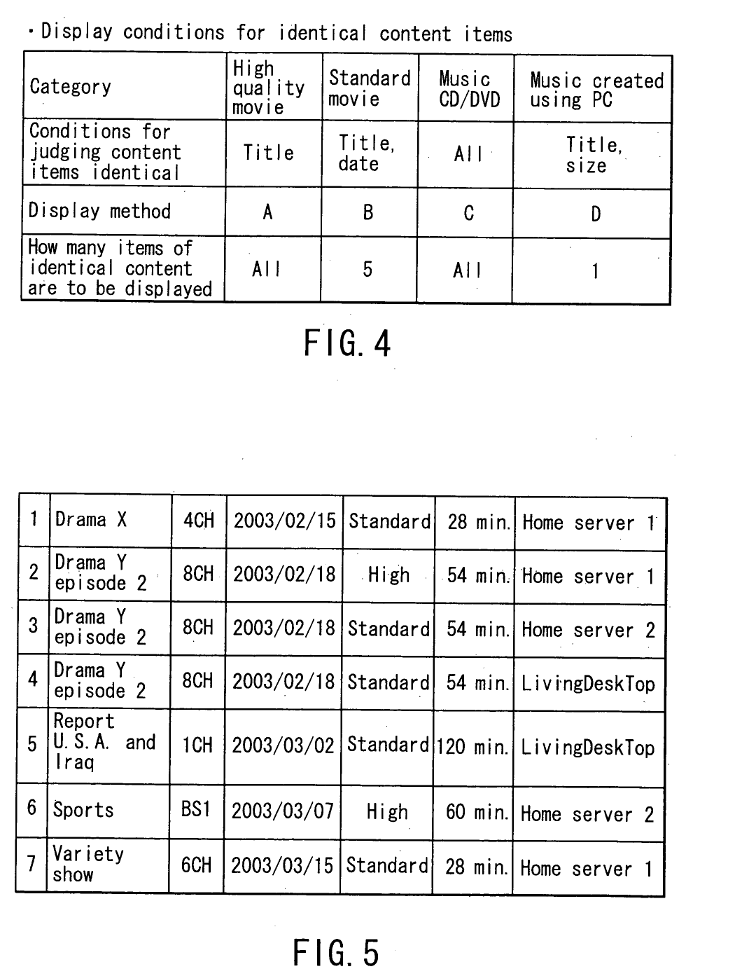

On the other hand, if identical content is present at different locations on the network, the content management server 10 acquires the content information that meets the criterion by which content is judged identical from the retrieved content information (“YES” in steps S4 and S5). The content management server 10, as shown in FIG. 4, determines whether identical content is present based on judgment information (conditions) for judging content identical, which is contained in the setting file defining display methods for use when identical content is present.

More specifically, when content is moving pictures (high quality movies) in the format of MPEG-2, if the “title,” contained in the content information, of a moving picture coincides with the “title,” contained in the content information, of another moving picture, the moving pictures are judged identical in content. For music content (content retrieved from CDs and DVDs), if and only if all items of the content information of a music file coincide with those of another music file, the music files are judged identical in content.

In the setting file shown in FIG. 4, the number of items identical in content (redundant content) that are to be displayed is defined for each category. For example, when content is moving pictures (high quality movies) in the format of MPEG-2, information on all moving pictures identical in content is displayed. For example, for music content items created using PCs, only one among items identical in content is displayed. As will be described later, the content item with the highest frequency of access is selected by set display method D.

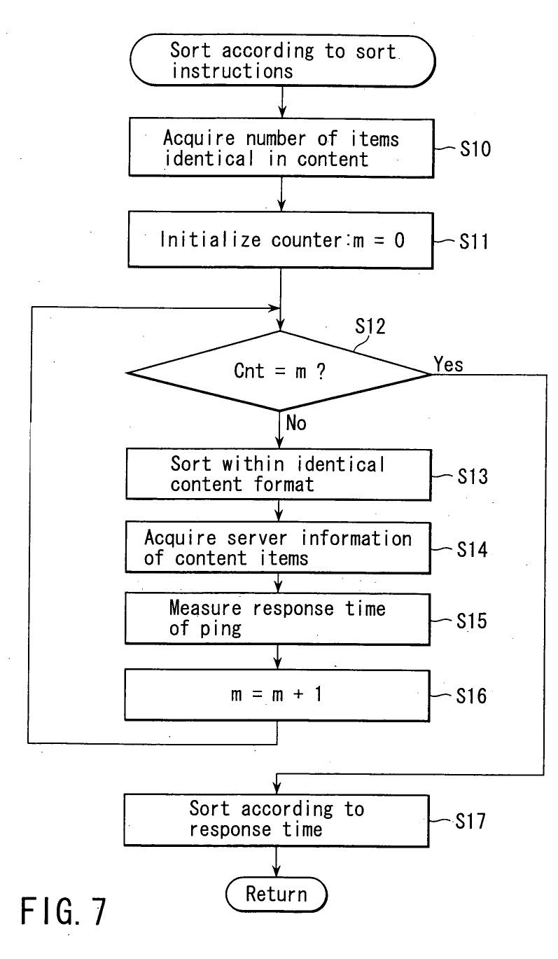

The content management server 10 performs designated sort processing, according to the contents of the setting file shown in FIG. 4, on the list information including identical content information (step S6). The steps of sort processing when identical content is present at different locations on the network will be described with reference to the flowchart of FIG. 7.

In the setting file, as shown in FIG. 4, display methods A to D are defined for the categories, respectively. Display method A is a method by which content items, which appear in identical content information, are displayed in decreasing order of response time of ping, which indicates the speed of network connection. The response time of ping is measured by the time taken to respond to the transmission of a ping command. Display method B is a method by which content items, which appear in identical content information, are displayed in decreasing order of response time to a query, which indicates transmission speed on a network. Display method C is a method by which the names of servers having content items, which appear in identical content information, are displayed in alphabetical order. Display method D is a method by which content items, which appear in identical content information, are displayed in the order of frequency of access.

The content management server 10, as shown in FIG. 7, acquires the number of items identical in content (Cnt) and initializes the internal counter (m) (steps S10 and S11). The content management server 10 performs sort processing on items identical in content format (category of FIG. 4) (step S13). Then, the content management server 10 acquires the server information of each content item, and further, measures the response time of ping, for example, to make it possible to execute display method A (steps S14 and S15).

The content management server 10 repeats steps S12 to S16 a number of times wherein the number is the number of items identical in content (Cnt), and sorts the content items in decreasing order of response time of ping (“YES” in step S12, and step S17). This processing is performed for each category.

FIG. 5 shows an example of a display in list form of recorded picture information, for example, of digital broadcast programs as content. In this example, the recorded information of items identical in content is shown in the second to fourth rows with an identical title, “Drama Y Episode 2.” In this example, items identical in content but belonging to different categories are displayed. In such a case, category order is given the highest priority. Therefore, the information corresponding to the content stored in server name “Home Server 1” corresponding to, for example, the digital TV 40 is given the highest priority in the display order. Further, within the same category, if, for example, display method A is set, content items are displayed in decreasing order of response time of ping. Therefore, the information corresponding to the content stored in server name “Home Server 2” corresponding to, for example, the RD 50 is given the second highest priority in the display order. Next, the information corresponding to the content stored in server name “Living Desk Top” corresponding to, for example, the PC 30 is displayed.

As described above, according to the embodiment, content distributed among the AV devices on the network is collectively managed, and the content list display function of collectively displaying a list of content information based on category and designated display methods when identical content is present at different location on the network, by the content management server providing the service of accessing to each content, is realized.

(Another Embodiment)

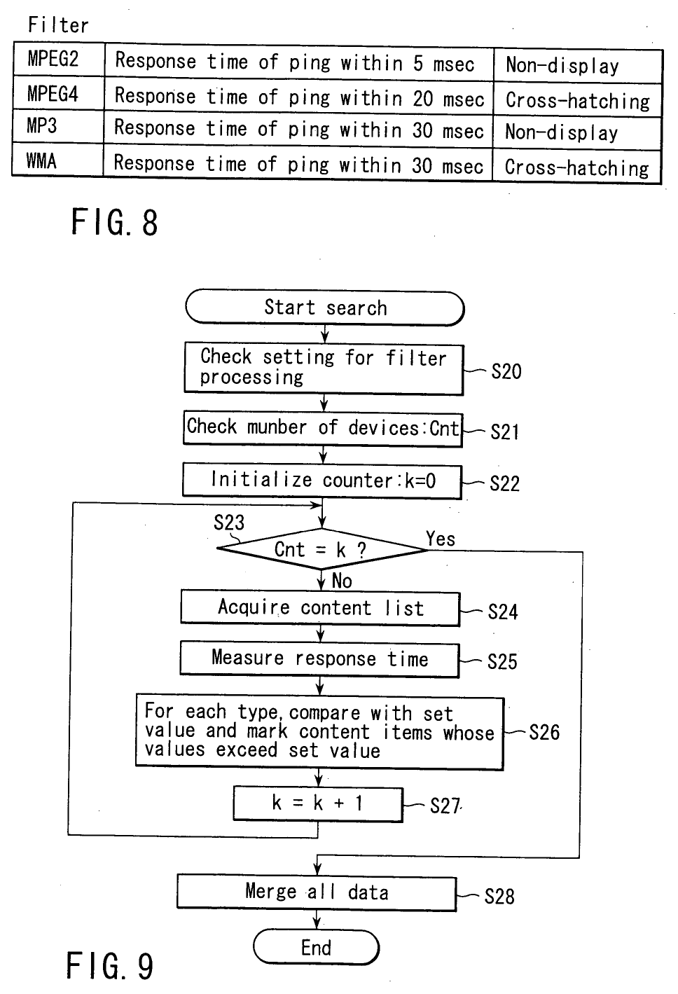

FIGS. 8 and 9 relate to another embodiment. This embodiment relates to an extension of the content list display function of the content management server 10 called filter function, which establishes the display style (such as non-display) of content items failing to meet the required reproduction conditions.

More specifically, the filter function according to the embodiment is a function of performing, for each type of content (reproduction format shown in FIG. 3), processing such as removing the content items, the reproduction of which at a satisfactory level is not guaranteed, from the display list based on the response time of the servers managing the content items (for example, the response time of ping).

The steps of the processing according to the embodiment will now be described with reference to the flowchart of FIG. 9.

The content management server 10, when searching for content information of AV content present on the network including the XMLDB 24 of the content management server 10 itself, checks a setting file for filter processing (Step S20).

The filter-setting file, as shown in FIG. 8, contains, for each content format (such as MPEG-2, MPEG-4, MP3 and WMA), information on response time of ping as a filter value and information for designating a display mode such as “non-display” or “cross-hatching display” when the filter value is exceeded.

The user can chose any value for each filter value in the filter-setting file. Designation of “non-display” with respect to a content item means removal of the content item from the display list. Designation of “Cross-hatching display” with respect to a content item means that although the content item is displayed in the list, its transmission speed is slow.

The content management server 10 checks the number of AV devices which it has access to (Cnt), and initializes the internal counter (k) (steps S21 and S22). The content management server 10 acquires the list information of the content managed by each AV device (step S24).

Next, the content management server 10 measures the response time of ping of each AV device managing content (step S25). The content management server 10 compares for each content type the measurement results and the filter value defined in the filter-setting file, and performs filtering processing of the content items whose measurement results exceed the filter value (step S26). More specifically speaking, if the format of content contained in the list information is, for example, “MPEG-2,” and the measurement result of a content item exceeds the filter value, the processing in which the content item is removed from the list information is performed. If the format of content contained in the list information is, for example, “MPEG-4,” and the measurement result of a content item exceeds the filter value, the display of the content information corresponding to the content item is set to cross-hatching display.

The content management server 10 repeats the above-described processing for a number of times wherein the number is the number of all AV devices that the content management server 10 has access to (step S27). When that is completed, all content information is merged and display list information of the content items is created (“YES” in step S23, and step S28).

As described above, according to the embodiment, when creating a display list of all content present on the network and displaying it, the filter function of removing the content items failing to meet the reproduction conditions, i.e., the content items, the reproduction of which at a satisfactory level is not guaranteed, based on the filter value defined for each content reproduction format, and of changing the style of display, for example, displaying in a special way, is realized.

More specifically, when reproducing video content in streaming format, there may be a case where smooth delivery is not possible depending on the type (format) of content because of the actual transmission speed between the client (PC 30 or digital TV 40) operated by the user and the server managing the content. Therefore, by deliberately removing particularly the content items managed by servers whose transmission speeds are slow, from the content list display, the user is prevented from selecting content items that cannot be reproduced at a satisfactory level from the display list. Consequently, at the time of reproduction, the interruption of the transmission of frames or occurrence of dropouts in sound resulting from such a selection is prevented.

It should be noted that in the embodiment, the reply speed of a server, measured based on the response time of the server to a ping command, is used as a reproduction condition filter value. However, the choice is not limited thereto, and the reply speed of a server measured based on the response time of the server to a query may also be used as a filter value. In addition, not only “non-display” and “cross-hatching display,” but also other display styles may be used in the filter processing.

As described above in detail, according to the embodiments, a content management apparatus that displays a list of content present on a network collectively in an easy-to-use way is provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A content management apparatus comprising:
acquiring means for acquiring content information indicative of attributes of content respectively stored in a plurality of storage devices connected to a network; and
sorting means for, when creating list information of the respective content using the content information and displaying the list information in a unified format, executing sort processing of the list information according to setting information defining display methods.

2. The content management apparatus according to claim 1, wherein the sorting means executes sort processing of the list information according to information in a setting file defining display methods for use when identical content is present, using the information in the setting file as the setting information.

3. The content management apparatus according to claim 1, wherein the sorting means determines whether identical content information is present among the content information acquired by the acquiring means based on conditions for determining whether identical content is present, and executes designated sort processing of the list information including the identical content information.

4. The content management apparatus according to claim 1, wherein the sorting means determines whether identical content information is present among the content information acquired by the acquiring means according to judgment information for determining whether identical content is present, and executes designated sort processing of the list information including the identical content information according to information in a setting file defining display methods for use when identical content is present, using the information in the setting file as the setting information.

5. The content management apparatus according to claim 1, wherein the setting information is information in a setting file containing information for determining, for each category of content, whether identical content is present and information defining display methods for use when identical content is present.

6. The content management apparatus according to claim 1, further comprising:
display means for displaying in list form the list information sorted by the sorting means.

7. The content management apparatus according to claim 1, wherein said sorting means is further operative for creating display list information according to filter-setting information defining additional display methods.

8. A content management apparatus comprising:
acquiring means for acquiring content information indicative of attributes of content respectively stored in a plurality of storage devices connected to a network; and
sorting means for, when creating list information of the respective content using the content information and displaying the list information in a unified format, creating display list information according to filter-setting information defining display methods.

9. The content management apparatus according to claim 8, wherein the sorting means executes processing in which content failing to meet a content reproduction condition defined by the filter-setting information is removed from the list information.

10. The content management apparatus according to claim 8, wherein the sorting means creates the display list information defining a display style of content information of content failing to meet a content reproduction condition defined by the filter-setting information, which is different from a display style designated to other content information.

11. The content management apparatus according to claim 8, wherein the filter-setting information is information in a file defining, for each reproduction format of content, a permissible range of transmission speeds of a server managing content as a content reproduction condition, and each designation information of a display style for use when transmission speed of the server is outside the permissible range.

12. A content management method applied to a content management apparatus collectively managing content respectively stored in a plurality of storage devices connected to a network, comprising the steps of:
acquiring content information indicative of attributes of content from each of the storage devices;
executing first sort processing for creating list information to be displayed in a unified format using the content information; and
executing second sort processing on the list information after the first sort processing according to setting information defining display methods for use when identical content is present.

13. The content management method according to claim 12, wherein the step of executing the second sort processing includes processing in which order of priority in displaying applicable content information is defined based on transmission speed of each server managing identical content.

14. The content management method according to claim 12, further including executing filter processing in which, using filter-setting information defining additional display methods according to content reproduction conditions, content failing to meet the reproduction conditions is identified from the list information and a display style of the identified content is set; and
creating display list information for displaying the list information in a unified format including the display style of the identified content set by the filter processing.

15. A content management method applied to a content management apparatus collectively managing content respectively stored in a plurality of storage devices connected to a network, comprising the steps of:
acquiring list information of content from each of the storage devices;
executing filter processing in which, using filter-setting information defining display methods according to content reproduction conditions, content failing to meet the reproduction conditions is identified from the list information and a display style of the content is set; and
creating display list information for displaying the list information in a unified format including the display style set by the filter processing.

16. The content management method according to claim 15, wherein in the step of executing the filter processing, the display style of the content failing to meet the reproduction conditions is set to non-display such that the content is removed from the list information.

17. A content management apparatus comprising:
an acquiring unit which acquires content information indicative of attributes of content respectively stored in a plurality of storage devices connected to a network; and
a sorting unit which operates, under software control, to execute sort processing of list information according to setting information defining display methods, said sorting unit operative when creating said list information of the respective content using the content information.

18. The content management apparatus according to claim 17, wherein the sorting unit executes sort processing of the list information according to setting information stored in a setting file defining display methods for use when identical content is present, said setting unit using the information in the setting file as the setting information.

19. The content management apparatus according to claim 18, wherein the sorting unit operates for additional creating display list information according to filter-setting information defining additional display methods.

20. The content management apparatus according to claim 19, wherein the sorting unit executes processing in which content failing to meet a content reproduction condition defined by the filter-setting information is removed from the list information.
